(19) United States
(12) Patent Application Publication
(10) Pub. No.: US 2004/0046060 A1
(43) Pub. Date: Mar. 11, 2004

(54) Fuel injection valve

(76) Inventor: Walter Maurer, Korntal-Munchingen (DE)

Correspondence Address: KENYON & KENYON, ONE BROADWAY, NEW YORK, NY, 10004, US

(21) Appl. No.: 10/381,686

(22) PCT Filed: May 7, 2002
(86) PCT No.: PCT/DE02/01641

(30) Foreign Application Priority Data
Jul. 27, 2001 (DE) 101 36 807.0

(51) Int. Cl. F02M 59/00

(52) U.S. Cl. 239/533.2

(57) ABSTRACT

A fuel injector, in particular a fuel injector for fuel-injection systems of internal combustion engines, has a piezoelectric or magnetostrictive actuator (1), which is situated between a valve body (12) and an actuator head (15) and, by way of a valve needle, actuates a valve-closure member which cooperates with a valve-seat surface to form a sealing seat. A spherical sleeve (16), which in the longitudinal section is convexly formed between two diameters, seals the actuator (1) from a fuel chamber (14) and encloses the actuator (1), the spherical sleeve (16) being joined at its ends to the valve body (12) and the actuator head (15) by force-locking and being tensilely prestressed in a longitudinal direction of the actuator.

### BACKGROUND INFORMATION

The present invention is directed to a fuel injector of the type set forth in the main claim.

A fuel injector according to the definition of the species in claim 1 is known from DE 40 05 455. The fuel injector for an internal combustion engine has at least one spray-discharge orifice which is connected to at least one supply line for pressurized fuel. A valve needle, which closes or releases the spray-discharge orifice, is connected to a piezoelectric actuator. A spring membrane seals a first chamber, which contains no fuel and includes the actuator, from a second chamber which holds fuel. The spring membrane generates a closing force acting upon the valve needle, this closing force acting upon the non-actuated actuator.

Disadvantageous in this known related art is that the actuator, in addition to the closing force of the spring membrane, is acted upon by a pressure force of the fuel. This pressure force compresses the actuator and reduces the starting length of the non-activated actuator. An impermissibly large play develops in the transmission path between actuator and valve-closure member. When the actuator is activated, part of the lift is lost to overcoming this play.

### SUMMARY OF THE INVENTION

In contrast, the fuel injector according to the present invention having the characterizing features of the main claim, has the advantage over the related art that only a slight change in the prestress force takes place. When an increased fuel pressure acts upon the surface of the convexly outwardly shaped spherical sleeve, the spherical sleeve is compressed and exerts a spreading force in its longitudinal direction between the valve body and actuator head. The fuel pressure also acting upon the actuator head counters this by a force that acts in the opposite direction. In this way, it is possible to advantageously prevent that the actuator is compressed by an increasing fuel pressure and the starting length of the actuator is changed to in impermissible extent.

Advantageous further developments of the fuel injector specified in the main claim are rendered possible by the measures given in the dependent claims.

In an advantageous manner, the contour of the spherical sleeve in longitudinal section and the elasticity of the material from which the spherical sleeve is made, are mutually adjusted, so that the surface of the spherical sleeve, given an increased pressure by the surrounding fuel, sweeps over the same volume as the actuator head.

The contour of the spherical sleeve, relative to an imaginary center line through the axis of symmetry of the spherical sleeve, is a line that essentially curves convexly toward the outside. By adapting the mentioned parameters, elasticity of the material and the form of the contour, a mechanical translation may be generated in such a way that the forces precisely cancel each other out. This is exactly the case when the volume gained by compressing the surface of the spherical sleeve corresponds to the volume displaced by the actuator head at that very moment. The actuator is advantageously not compressed when a pressure increase occurs since the increase in pressure does not exerts additional force on the actuator. Therefore, the starting length of the actuator is not dependent on the fuel pressure since the initial stress of the actuator does not change.

In one advantageous embodiment, the longitudinal section and the elasticity of the spherical sleeve are mutually adjusted in such a way that the changed length of the actuator corresponds to the expansion of the valve body in response to an increasing fuel pressure. When the fuel pressure is increased, the valve body expands as well. This may cause faults in the transmission path of the opening force from the actuator to the valve-closure member as a result of impermissible play occurring between transmission components. This may be compensated by an appropriate selection of characteristics of the spherical sleeve in response to a change in the fuel pressure. Depending on the selected power-translator ratio of the pressure force exerted by the fuel on the surface of the spherical sleeve in relation to the pressure force exerted on the actuator head, it may be determined in which direction the starting length of the actuator is adapting in response to a change in the fuel pressure.

In one advantageous embodiment, a cylindrical spring sleeve, able to be compressed in the longitudinal direction, adjoins the spherical sleeve, and a support ring is situated between the spherical sleeve and the spring sleeve.

This embodiment is especially advantageous in that it is possible, in a cost-effective production for a variety of actuators, to adjust the expansion compensation characteristics of the spherical sleeve in combination with the actuator head, without a special spherical sleeve being required in each case. The spring sleeve is not radially compressible, but may only be compressed in the longitudinal direction. An adaptation to different actuator lengths is easy to accomplish. Due to the inserted support ring, the functions of the spring sleeve and the spherical sleeve are clearly separated in an advantageous manner and an undesired compression of the spring sleeve prevented.

In one advantageous embodiment, a spring sleeve enclosing the actuator is provided inside the spherical sleeve and connected to the valve body and the actuator head by force-locking.

By this embodiment as well, using one and the same spherical sleeve, it is possible to produce different characteristics in response to changing fuel pressures.

### BRIEF DESCRIPTION OF THE DRAWINGS

An exemplary embodiment of the present invention is represented in the drawing in simplified form and explained in greater detail in the following description.

The figures show:

FIG. 1 a schematic detailed section through a fuel injector configured according to the related art, in the region of the actuator;

FIG. 2 a schematic detailed section through a first embodiment of a fuel injector configured according to the present invention, in the region of the actuator;

FIG. 3 a schematic detailed section through an additional embodiment of a fuel injector configured according to the present invention, in the region of the actuator; and

FIG. 4 a schematic detailed section through a further embodiment of a fuel injector configured according to the present invention, in the region of the actuator.

### DESCRIPTION OF THE EXEMPLARY EMBODIMENT

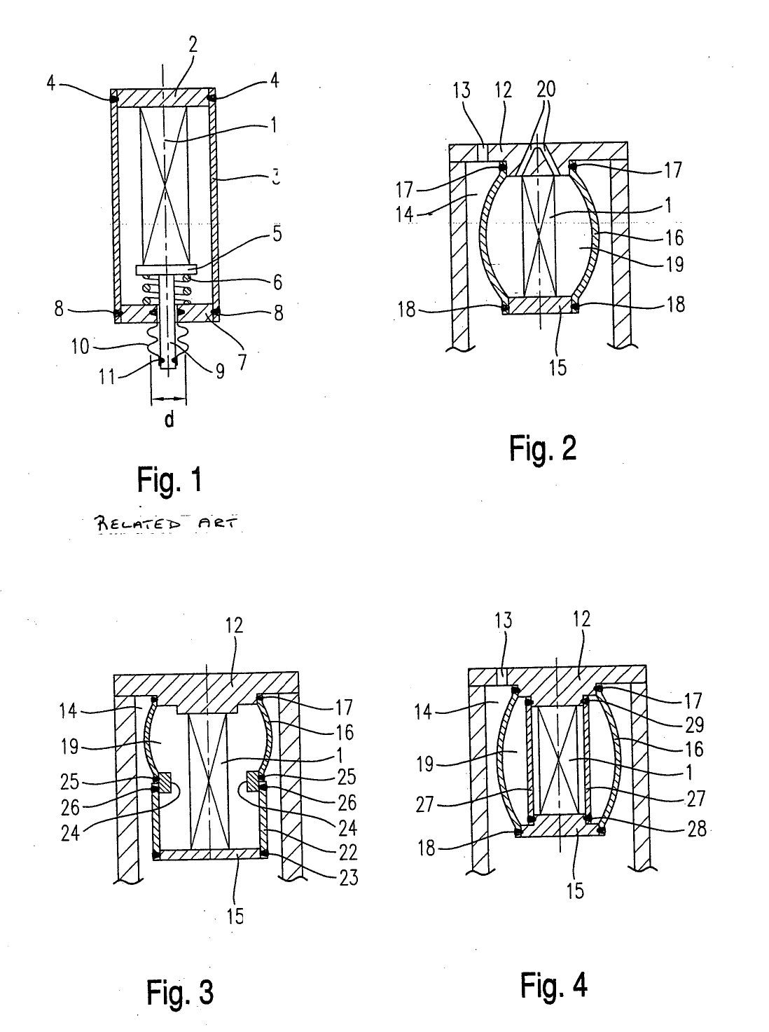

FIG. 1 shows a detailed section through a fuel injector according to the related art in the region of a piezoelectric actuator 1 situated on a support 2 and sealed from the chamber containing surrounding fuel by a sealing sleeve 3. Support 2 and sleeve 3 are joined via a welded seam 4. Actuator 1 is prestressed in the direction of support 2 by an actuator head 5 and a helical spring 6, which is braced against a cover plate 7. Cover plate 7 and sleeve 3 are connected to one another by an annular welded seam 8 which seals from the fuel. Actuator head 5 has a pressure piston 9 formed in one piece with actuator head 5, which passes through an opening in support plate 7. A corrugated tube 10, joined to pressure piston 9 by a welding seam 11, is used for sealing.

When the pressure of the surrounding fuel increases, the pressure force of the fuel acts upon a circular disk having an approximate diameter d as effective diameter, which is transmitted to actuator 1 via pressure piston 9 and actuator head 5. This force is in addition to the prestressing force exerted upon actuator 1 by helical spring 6 and compresses actuator 1, which has only a relatively low rigidity. This causes a disadvantageous reduction in the starting length of actuator 1. In a fuel injector designed for injecting fuel this may amount to up to 30% of the nominal lift.

FIG. 2, in contrast, shows a schematic detailed section through a first embodiment of a fuel injector configured according to the present invention, in the region of a piezoelectric or magnetostrictive actuator 1. A fuel feed 13 leading to a fuel chamber 14 is provided in a valve body 12. Actuator 1 is identical to actuator 1 configured according to the related art in FIG. 1. Actuator 1 is situated between valve body 12 and an actuator head 15. A spherical sleeve 16 is joined to valve body 12 by a welded seam 17 and to actuator head 15 by an additional welded seam 18. Welded seams 17, 18 and actuator head 15 as well as spherical sleeve 16 seal actuator 1, which is situated in an actuator chamber 19, from fuel chamber 14. Electrical lines are able to be lead to actuator 1 via connection conduits 20.

In response to a pressure increase in fuel chamber 14, spherical sleeve 16 is compressed and takes on a more cylindrical form. However, this is counteracted by the force exerted on actuator head 15 by the pressure of the fuel. At the same time, spherical sleeve 16 has an initial stress in the longitudinal direction of actuator 1, so that both ends of actuator 1 are acted upon by an initial stress, both at valve body 12 and actuator head 15, the stress being directed towards each other, and actuator 1 rests against valve body 12 and valve head 15. If the volume swept over by the surface of spherical sleeve 16 equals the volume that is swept over by the extension of spherical sleeve 16 and the movement of actuator head 15 resulting therefrom, the forces produced in response to an increase in fuel pressure in fuel chamber 14 cancel each other out. Independently of the pressure prevailing in fuel chamber 14, the length of actuator 1 is then determined solely by the initial stress of spherical sleeve 16. The length of actuator 1 and, thus, the possible lift is entirely decoupled from the pressure prevailing in fuel chamber 14. Additional advantages are the less complicated design which uses fewer components and the shortened length of the unit made up of spherical sleeve 16, actuator 1 and actuator head 15. This can easily been seen by a comparison with FIG. 1.

FIG. 3 shows a section through an additional embodiment of a fuel injector configured according to the present invention, in the region of an actuator 1. Equivalent parts are denoted by the same reference numerals. Actuator 1 is situated between valve body 12 and actuator head 15. Spherical sleeve 16 is connected to valve body 12 by welded seam 17. In addition, the present embodiment has a spring sleeve 22 which is located between actuator head 15 and spherical sleeve 16. Spring sleeve 22 is joined to actuator head 15 by a welded seam 23. Situated between spherical sleeve 16 and spring sleeve 22 is a support ring 24 to which spherical sleeve 16 is connected via a welded seam 25 and to spring sleeve 22 via an additional welded seam 26.

Spring sleeve 22 is not radially compressible, but may only be compressed in the longitudinal direction. In this way, the characteristic curve of the longitudinal extension of actuator 1 may be easily adapted via the pressure in fuel chamber 14 to a particular application case, without this in each case requiring a specially adapted spherical sleeve 16 or a specially adapted actuator 15.

FIG. 4 shows a section through an additional embodiment of a fuel injector configured according to the present invention, in the region of an actuator 1. The schematic design corresponds to that of the embodiment in FIG. 2. Actuator 1 is positioned between valve body 12 and actuator head 15. Spherical sleeve 16 is affixed on valve body 12 by a welded seam 17 and on actuator head 15 by welded seam 18. Fuel is able to be conveyed to a fuel chamber 14 via a fuel feed 13. Inside actuator chamber 19 is a spring sleeve 27 which encloses actuator 1. Spring sleeve 27 is joined to valve body 12 by a welded seam 29 and to actuator head 15 by an additional welded seam 28.

In an advantageously simple manner, the characteristic curve of the longitudinal change of actuator 1 in response to increased pressure in fuel chamber 14 is able to be controlled via spring sleeve 27. Since spring sleeve 27 is inside actuator chamber 19 and is not acted upon by the fuel in fuel chamber 14, the outer geometry of spring sleeve 27 is irrelevant. Since spring sleeve 27 is joined to valve body 12 by force-locking via welded seam 29 and likewise via welded seam 28 to actuator head 15, a regulation may also be implemented to the effect that spring sleeve 27 exerts an additional tensile force. This makes it possible to adapt the pressure characteristics of actuator 1 in a very cost-effective manner, solely by installing an adapted spring sleeve 27.

The present invention is not limited to the exemplary embodiments shown, but may also be used in a multitude of other configurations of fuel injectors; in particular, a different sequence of spring sleeves and spherical sleeves, or a repeated sequence of spring sleeves and spherical sleeves arranged one after the other or enclosing one another is also conceivable.

What is claimed is:

1. A fuel injector, in particular a fuel injector for fuel-injection systems of internal combustion engines, having a piezoelectric or magnetostrictive actuator (1) situated between a valve body (12) and an actuator head (15), and a valve-closure member, which is operable by the actuator (1) by way of a valve needle and which cooperates with a valve-seat surface to form a sealing seat,
wherein a spherical sleeve (16), which in the longitudinal section is convexly formed at its ends between two diameters, seals the actuator (1) from a fuel chamber (14) and encloses it, the spherical sleeve (16) being joined at its ends to the valve body (12) and the actuator head (15) by force-locking and being tensilely prestressed in a longitudinal direction of the actuator (1).

2. The fuel injector as recited in claim 1,
wherein the longitudinal section and the elasticity of the spherical sleeve (16) are adjusted to one another in such a way that, in response to a pressure increase in the surrounding fuel, the surface of the spherical sleeve (16), sweeps over the same volume as the actuator head (15).

3. The fuel injector as recited in claim 1,
wherein the longitudinal section and the elasticity of the spherical sleeve (16) are adjusted to one another in such a way that the change in the length of the actuator (1) corresponds to the expansion of the valve body (12) in response to a pressure increase in the fuel.

4. The fuel injector as recited in one of the claims 1 through 3,
wherein a cylindrical spring sleeve (22), which is compressible in the longitudinal direction, adjoins the spherical sleeve (16).

5. The fuel injector as recited in claim 4,
wherein a support ring (24) is situated between the spherical sleeve (16) and the spring sleeve (22).

6. The fuel injector as recited in claim 4 or 5,
wherein a plurality of spherical sleeves (16) and spring sleeves (22) follow one another in succession in the longitudinal direction.

7. The fuel injector as recited in one of claims 1 through 6,
wherein a spring element enclosing the actuator (1) is situated inside the spherical sleeve (16).

8. The fuel injector as recited in claim 7,
wherein the spring element is a spring sleeve (27).

9. The fuel injector as recited in claim 8,
wherein the spring sleeve (27) is joined to the valve body (12) and the actuator head (15) by force-locking.
